(19) United States
(12) Patent Application Publication
(10) Pub. No.: US 2019/0213920 A1
(43) Pub. Date: Jul. 11, 2019

(54) Structure Improvement of Digital Perpetual Clock

(71) Applicant: Kuei-Wen Sheu, Taipei City (TW)

(72) Inventor: Kuei-Wen Sheu, Taipei City (TW)

(21) Appl. No.: 16/314,443

(22) PCT Filed: Sep. 30, 2016
(86) PCT No.: PCT/CN2016/101221

§ 371 Date: Dec. 31, 2018

(51) Int. Cl. G09D 3/12; G04B 19/257

(52) U.S. Cl. CPC G09D 3/12; G04B 19/2573

(57) ABSTRACT

The present invention provides a flip clock, in particular to a structure improvement of the digital perpetual calendar clock capable of reducing the quantity of the page sheets. The perpetual calendar clock includes a first digit rotational roller and a second digit rotational roller; the two rotational rollers are provided with a plurality of page sheets to display the digits of the tens place and the ones place respectively. Moreover, the perpetual calendar clock further includes a carrying shaft element, and the two rotational rollers are embedded into the two ends of the carrying shaft member respectively at the same shaft. When the second digit rotational roller rotates, a rotational teeth member on the carrying shaft member drives the first digit rotational roller to rotate. The present invention can reduce the power consumption by using less digit page sheets.

### BACKGROUND OF THE INVENTION

### 1. Field of the Invention

The present invention relates to a flip clock, in particular to a structure improvement, for a flip clock, capable of reducing the quantity of the page sheets.

### 2. Description of the Prior Art

Regarding flip clock, there are already a lot of different designs or structures available in the market.

For example, all of the perpetual calendar clock structures of Taiwan Patent No. 186349 and Taiwan Patent No. M361651 owned by the applicant of the present invention are mainly composed of an outer housing, a rotational roller, a driving device and a battery set, and the sheet pages for displaying the digits are disposed on the rotational rollers according to the quantity of the digits necessary to be displayed. However, if the clocks should display the min and the sec based on the sexagesimal system, it is necessary to provide 60 wide page sheets in order to display the digits of 0-60 (e.g. min or sec).

Accordingly, a lot of page sheets disposed on the rotational rollers will increase the force needed for rotating the rotational rollers, which will further influence the power consumption of the driving device providing the rotational force for the rotational rollers. Thus, when the above structure is applied to a perpetual calendar clock which needs to display a lot of time digits and keep being in operation for a long time, its shortcomings will become very obvious. Therefore, all of the above conventional structures are not applicable and should be further improved.

In order to overcome the above shortcomings of the conventional structures, the inventor of the application has kept trying hard to improve and innovate the conventional structures; after many years, the invention of the application finally develops the structure improvement of the perpetual calendar clock of the present invention.

According to the above shortcomings, the inventor of the application develops the present invention by working hard for a long time via his professional knowledge in the field. The present invention can completely overcome the shortcomings of the prior art to provide a perpetual calendar clock definitely having utility and novelty.

### SUMMARY OF THE INVENTION

The present invention provides a structure improvement of a digital perpetual calendar clock, which is a flip clock capable of turning the page sheets via mechanical structure to show the digits. Compared with the prior art, the digital perpetual calendar clock needs less page sheets and the driving device thereof can be in intermittent operation, which not only can make the clock of the present invention works in the stepping status, but also can decrease the manufacturing cost.

The structure improvement of the digital perpetual calendar clock in accordance with the present invention includes the following elements:

An outer housing: the outer housing is used to contain the internal elements of the clock to prevent the internal elements from contacting external foreign objects. Besides, the surface of one side of the outer housing is provided with a clock window, so when the clock of the present invention is standing, the user can see the time show by the clock via the clock window.

A first digit rotational roller: the first digit rotational roller is provided with a plurality of page sheets, correspondingly disposed at regular intervals, along the edges of the wheel rims of the two sides of the roller. Each of the front side and the reverse side of each page sheet is provided with a half digit symbol. When one of two adjacent pages is turned down and the other of which is not turned down, the two half digits of the two pages can be connected to form a complete digit. The clock of the present invention is just to show the time via the digits of the page sheets. According to the present invention, the first digit rotational roller is mainly used to show the tens place of the two places.

A second digit rotational roller: the second digit rotational roller is also provided with a plurality of page sheets, correspondingly disposed at regular intervals, along the edges of the wheel rims of the two sides of the roller. Each of the front side and the reverse side of each page sheet is provided with a half digit symbol. Similar to the first digit rotational roller, when one of two adjacent pages is turned down and the other of which is not turned down, the two half digits of the two pages can be connected to form a complete digit; the digit shown on the page sheets stands for the time. According to the present invention, the second digit rotational roller is mainly used to show the ones place of the two places.

As described above, the first digit rotational roller is used to show the tens place of the time and the second digit rotational roller is used to show the ones place of the time. As the perpetual calendar clock needs to show the min and the sec of the time, the first digit rotational roller is provided with 12 page sheets, which can be used to orderly show the digits 0-5, and the circulation is orderly implemented for two times in total (0, 1, 2, 3, 4, 5, 0, 1, 2, 3, 4, 5); in addition, the second digit rotational roller is provided with 10 page sheets, which can be used to orderly show the digits 0-9, and the circulation is orderly implemented for one times in total (0, 1, 2, 3, 4, 5, 6, 7, 8, 9).

Further, the first digit rotational roller and the second digit rotational roller are disposed inside the outer housing, and the positions of the first digit rotational roller and the second digit rotational roller are corresponding to the clock window of the outer housing respectively. Thus, when the user looks the clock window, the user can see the digits on the page sheets of the first digit rotational roller and the second digit rotational roller.

The present invention further includes a carrying shaft member, and the carrying shaft member is an element whose lateral area is lower than that of the first digit rotational roller and the second digit rotational roller. Besides, one end thereof is embedded into the first digit rotational roller and the other end thereof is embedded into the second digit rotational roller, such that the carrying shaft member can be disposed between the first digit rotational roller and the second digit rotational roller, and a rotational shaft can penetrate through the three elements to make the three elements be at the same shaft.

Moreover, the inner edge, where the carrying shaft member are embedded, of the first digit rotational roller are provided with a plurality of protrusion teeth. As the perpetual calendar clock should display the min and the sec of the time, the quantity of the protrusion teeth disposed on the first digit rotational roller is 24. In addition, similarly, at the other side of the carrying shaft member, the inner edge, where the carrying shaft member are embedded, of the second digit rotational roller are also provided with a plurality of protrusion teeth; besides, there is a protrusion block disposed inside the perpetual calendar clock of the present invention.

Furthermore, the carrying shaft member of the present invention is provided with a rotational teeth member at the shaft different from the shaft where the carrying shaft member is disposed; the both sides of the rotational teeth member are provided with a plurality of protrusion teeth. More specifically, the protrusion teeth on one side thereof are engaged with the protrusion teeth of the first digit rotational roller and the protrusion teeth on the other side thereof are disposed toward the second digit rotational roller, such that when the second digit rotational roller rotates, the protrusion block disposed on the inner edge thereof can contact and push the rotational teeth member to be close to the protrusion teeth at the side of the second digit rotational roller. Moreover, as the perpetual calendar clock should display the min and the sec of the time, the quantity of the protrusion teeth, close to the first digit rotational roller, of the rotational teeth member is 8, and the quantity of the protrusion teeth, close to the second digit rotational roller, of the rotational teeth member is 4. Regarding the 8 protrusion teeth, 4 of the 8 protrusion teeth, spaced by the length of one tooth, and the other 4 teeth at the other side are fixed and arranged parallelly and correspondingly. Further, the rotational teeth member can rotate on its shaft, on the carrying shaft member, toward the direction parallel to the rotational directions of the first digit rotational roller and the second digit rotational roller.

In addition, regarding the carrying shaft member of the present invention, the outer edge of the carrying shaft member is provided with a cushion fixed thereon and extending therefrom (or called washer); the cushion may include a smooth surface. When the carrying shaft member, the first digit rotational roller and the second rotational roller are disposed at the same shaft, the cushion can isolate the first digit rotational roller from the second digit rotational roller, so the first digit rotational roller will not directly contact the second digit rotational roller so as to prevent the first digit rotational roller and the second digit rotational roller from being influenced by the frictional force between them. Besides, the cushion is provided with a hole for containing the rotational teeth member, so when assembling the clock, the 4 protrusion teeth and the 8 protrusion teeth of the rotational teeth member can be at the two sides of the cushion.

According to the present invention, please note that the rotational shaft penetrating through the carrying shaft member, the first digit rotational roller and the second digit rotational roller are a polygonal shaft instead of a circular shaft, and the shaft hole at the center of the carrying shaft member and the holes, for fixing the rotational shaft, at the two ends of the rotational shaft are also polygonal; however, the shaft holes at the centers of the first digit rotational roller and the second digit rotational roller are circular holes with the diameter equal to that of the length between two corners, opposite to each other, of the polygon. The above structure is to make the carrying shaft member be fixed on the outer housing via the rotational shaft, and the first digit rotational roller and the second digit rotational roller should be able to rotate. Moreover, the rotational teeth member on the carrying shaft member can rotate on its own shaft.

Furthermore, when the second digit rotational roller rotates counterclockwise, the direction from the second digit rotational roller to the first digit rotational roller, in relation to its rotational shaft, the protrusion block disposed on its inner edge will be engaged into the 4 protrusion teeth at the side of the rotational teeth member at a predetermined angle to make the rotational teeth member rotate. Then, the 8 protrusion teeth at the side of the rotational teeth member will be driven together with the rotational teeth member because the 24 protrusion teeth, on the inner edge of the first digit rotational roller, are engaged with the 8 protrusion teeth, so the first digit rotational roller is driven to rotate and perform carry for one time. Afterward, when the protrusion block on the inner edge of the second digit rotational roller pushes the rotational teeth member again, the above process will be repeated.

According to the present invention, the top of the clock window of the outer housing is provided with a blocking element; the blocking element is disposed at the top of the clock window inside the outer housing and can position and block all the page sheets, intermittently stepping, of the first digit rotational roller in order to avoid that the sheet pages are turned down too soon because being influenced by gravity when the predetermined angle has yet to be reached.

Besides, during the above process, the first digit rotational roller and the second digit rotational roller rotate counterclockwise along their rotational shafts; when the angle of the rollers change to reach a predetermined correct angle, all page sheets, intermittently stepping, disposed on the first digit rotational roller, or all page sheets, intermittently stepping, disposed on the second digit rotational roller are turned down via the blocking element, and the blocking element prevents the following page sheets from being turned down. In this way, the page sheet turned down connects to the page sheet blocked and not turned down to from a plane, so the page sheets can show the first digit (tens place) or second digit (ones place) before the next page sheets are turned down in order to display the time of the clock.

The present invention further includes a driving device and the driving device is disposed on the outer housing in order to drive the second digit rotational roller to rotate. The second digit rotational roller rotates in the direction toward the bottom of the clock window of the outer housing. When the view angle is from the second digital rotational roller to the first digit rotational roller, both of the second digital rotational roller and the first digit rotational roller rotate counterclockwise. Then, the driving device can receive the time signals from an external reed switch or micro switch to make the clock be operated in intermittently stepping manner. In this way, the clock can correctly be operated to display the time.

Besides, the other side, where the carrying shaft member is embedded, of the first digit rotational roller is provided with a limiting element for preventing the first digit rotational roller from rotating reversely (in other words, the limiting element is used to prevent the first digit rotational roller from rotating toward the top of the clock window). When the rotational angle of the first digit rotational roller is accumulated to a predetermined degree (or number of turns), the carrying element is contacted; meanwhile, the carrying element transmits a carrying signal to other external clocks the same with the clock of the present invention or other different clocks, which means that the clock of the present invention has already be operated for a complete cycle, such that the clocks connected to the clock of the present invention displaying different time or date can work normally. The above structure can also be used to connect a plurality of clocks of the present invention with one another in order to transmit the carrying signal between these clocks of the present invention, such that these clocks of the present invention can correctly display the time.

Compared the structure improvement of the digital perpetual calendar clock of the present invention with the prior art, the digital perpetual calendar clock of the present invention can decrease the weight of the page sheets disposed thereon and reduce the power consumption during the operation in order to allow the digital perpetual calendar clock to be able to operate for a long time.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is the front view of the structure improvement of the digital perpetual calendar clock in accordance with the present invention.

FIG. 2 is the structure diagram in the first viewing angle of the rollers and the shaft member of the structure improvement of the digital perpetual calendar clock in accordance with the present invention.

FIG. 3 is the structure diagram in the second viewing angle of the rollers and the shaft member of the structure improvement of the digital perpetual calendar clock in accordance with the present invention.

FIG. 4 is the first schematic view of the operation status of the structure improvement of the digital perpetual calendar clock in accordance with the present invention.

FIG. 5 is the second schematic view of the operation status of the structure improvement of the digital perpetual calendar clock in accordance with the present invention.

FIG. 6 is the third schematic view of the operation status of the structure improvement of the digital perpetual calendar clock in accordance with the present invention.

FIG. 7 is the fourth schematic view of the operation status of the structure improvement of the digital perpetual calendar clock in accordance with the present invention.

### DETAILED DESCRIPTION OF THE PREFERRED EMBODIMENT

The following description is about embodiments of the present invention; however it is not intended to limit the scope of the present invention.

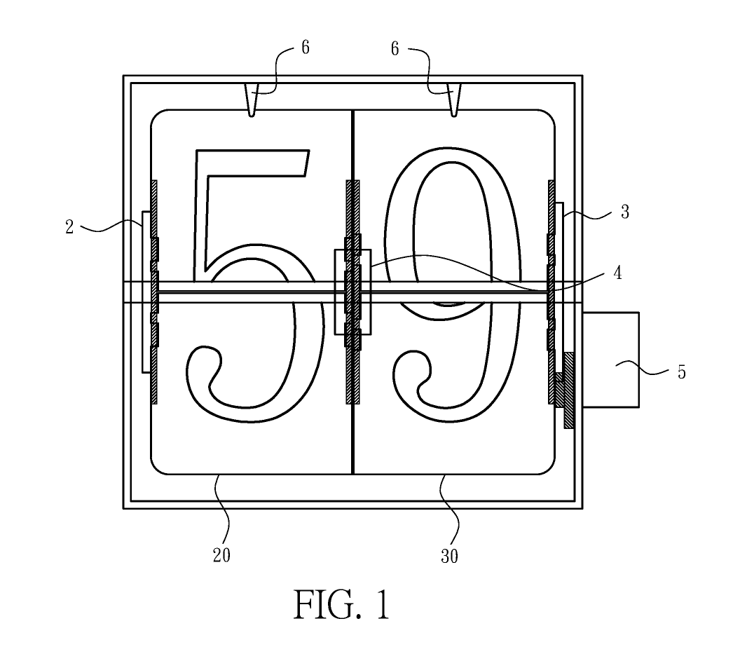

With reference to FIG. 1 for the front view of the structure improvement of the digital perpetual calendar clock in accordance with the present invention, the digital perpetual calendar clock includes an outer housing 1 covering the clock. When the user looks the clock window, the first digit rotational roller 2, the carrying shaft member 4 and the second digit rotational roller 3 are orderly disposed at the same shaft from left to right. The page sheet 20 is disposed on the first digit rotational roller 2 for displaying the digit and the page sheet 30 is disposed on the second digit rotational roller 3 for displaying the digit. The blocking element is disposed on the top of the clock window of the outer housing 1 by a predetermined angle and used to prevent the page sheet 20 and the page sheet 30 from being turned down too soon due to gravity, during the rotation of the rollers 2, 3, when they are tilted by an angle. The driving device 5 is disposed on the outer housing 1; the driving device 5 pushes the slot-type wheel on the second digit rotational roller 3 via the rotation of the circular pin wheel, which can intermittently drive the second digit rotational roller 3.

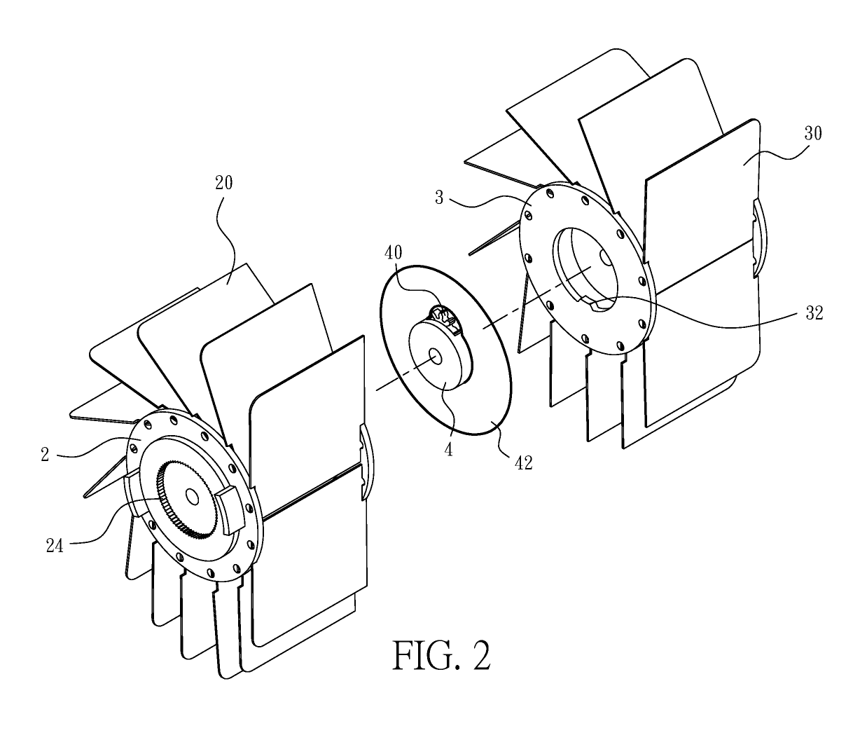

With reference to FIG. 2 for the structure diagram in the first viewing angle of the rollers and the shaft member of the structure improvement of the digital perpetual calendar clock in accordance with the present invention, at the left side is the first digit rotational roller 2, which includes 12 movable page sheets 20. As shown in FIG. 2, one side of the first digit rotational roller 2 is provided with a ring and the inner edge of the ring is provided with a plurality of converse teeth 24; besides, there are 2 carrying protrusion blocks 28 on the ring; the carrying protrusion blocks 28 can respectively trigger the micro switch (not shown in the drawings) on or inside the outer housing 1 when the first digit rotational roller 2 makes a half circle in order to generate a carrying signal. In addition, at the right side is the second digit rotational roller 3, which includes 10 movable page sheets 30; besides, the inner edge of the recess of the inner side thereof is provided with a protrusion block 32; in the embodiment, the protrusion block 32 is arranged according to the distance between 2 teeth.

Moreover, the carrying shaft member 4 is provided with a rotational teeth member 40 and the shaft core of the rotational teeth member 40 is disposed inside the carrying shaft member 4. One side, close to the first digit rotational roller 2, of the rotational teeth member 40 is provided with 8 protrusion teeth and the other side, close to the second digit rotational roller 3, thereof is provided with 4 protrusion teeth. The outer edge of the carrying shaft member 4 is provided with a cushion thereon and extending therefrom; the surfaces of the both sides of the cushion may be smooth. The cushion 42 is provided with a hole at the corresponding position so as to contain the rotational teeth member 40, and the 8 protrusion teeth and the 4 protrusion teeth of the rotational teeth member 40 are on the both sides of the cushion 42 respectively.

More specifically, when the polygonal rotational shaft penetrates through the first digital rotational roller 2, the carrying shaft member 4 and the second digit rotational roller 3 to combine these elements by the same shaft, one end of the carrying shaft member is embedded into one side of the first digit rotational roller 2 and the other end thereof is embedded into one side of the second digit rotational roller 3. In addition, the carrying shaft member 4 is fixed by the polygonal rotational shaft, but the first digit rotational roller 2 and the second digit rotational roller 3 can rotate. When the second digit rotational roller 3 rotates, the protrusion block 32 can contact the 4 protrusion teeth of the rotational teeth member 40 of the carrying shaft member 4 in order to drive the rotational teeth member 40 to rotate; in this way, the mutual link of the rotational teeth member 40 can be achieved by the parallel arrangement of the 4 protrusion teeth and the 8 protrusion teeth.

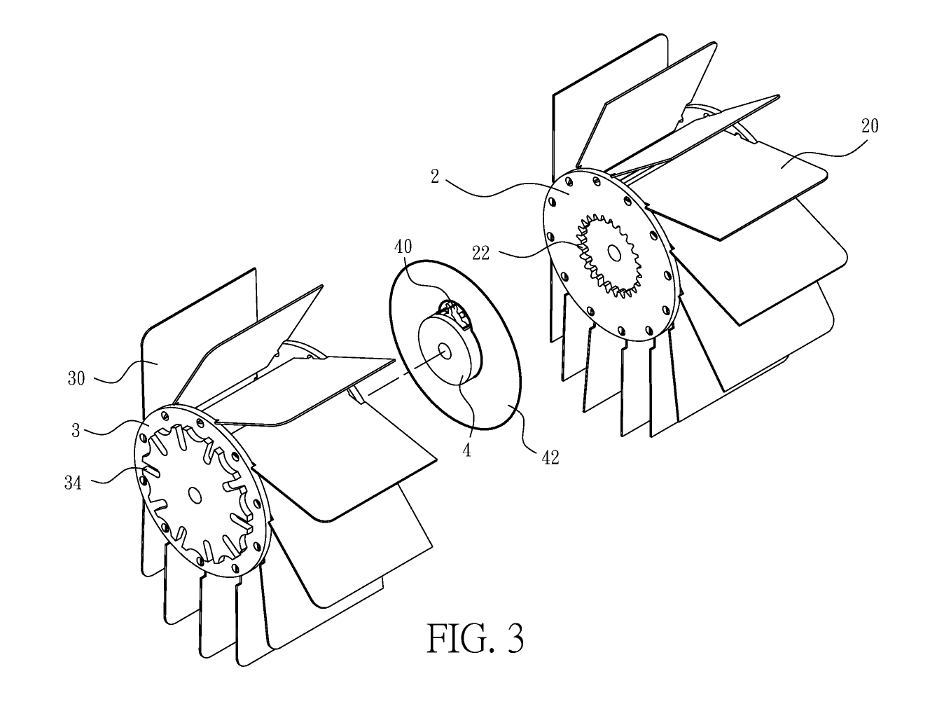

With reference to FIG. 3 for the structure diagram in the second viewing angle of the rollers and the shaft member of the structure improvement of the digital perpetual calendar clock in accordance with the present invention, at the left side is the second digit rotational roller 3 and there are 12 movable page sheets 30 disposed thereon. Besides, this side of the second digit rotational roller 3 is provided with a slot-type wheel 34 with arc recesses on the peripheral thereof. The slot-type wheel 34 includes a plurality of long recesses and a plurality of seminar recesses on the peripheral thereof. On the other hand, at the right side is the first digit rotational roller 2; similarly, there are 12 movable page sheets disposed on the first digit rotational roller 2 and the inner side thereof is provided with a circular recess which the carrying shaft member 4 is embedded into in the combination status; further, the edge of the inner side of the circular recess is provided with 24 protrusion teeth 22. When the first digit rotational roller 2, the carrying shaft member 4 and the second digit rotational roller 3 are combined at the same shaft, one end of the carrying shaft is embedded into the first digit rotational roller 2, such that the rotational teeth member 40 on the carrying shaft member 3 are engaged with the 24 protrusion teeth 22. In addition, when the rotational teeth member 40 on the carrying shaft member 4 rotates, the 24 protrusion teeth 22 engaged with the rotational teeth member 40 drives the first digit rotational roller 2. Further, the cushion 42 on the carrying shaft member 4 isolates the first digit rotational roller 2 and the second digit rotational roller 3, such that when the first digit rotational roller 2 and the second digit rotational roller 3 rotate, only the rotational teeth member 40 can transmit power but no frictional force generates; on the contrary, if the carrying shaft member 4 does not include the cushion 42, the first digit rotational roller 2 and the second digit rotational roller 3 will be influenced by the frictional force generating therebetween.

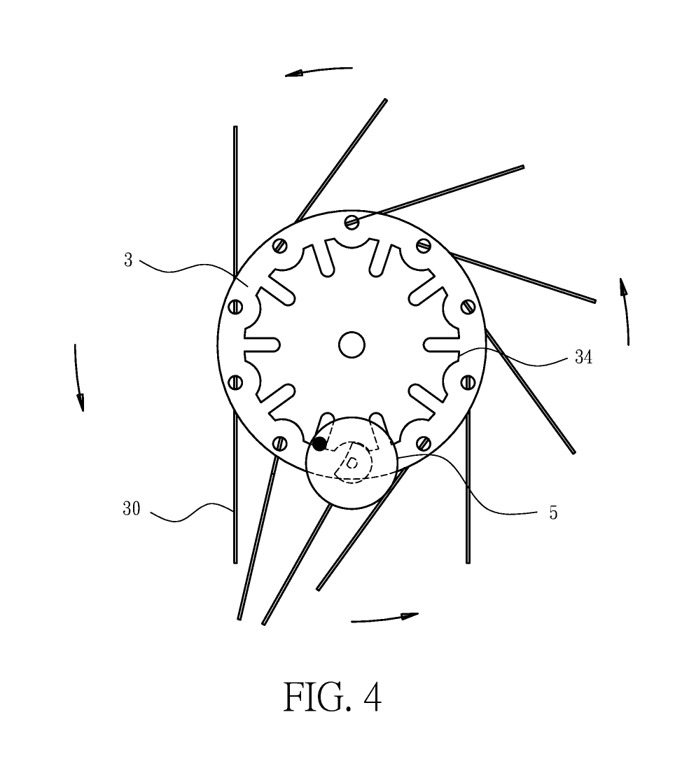

With reference to FIG. 4 for the first schematic view of the operation status of the structure improvement of the digital perpetual calendar clock in accordance with the present invention, FIG. 4 shows the view angle from the outer side of the second digit rotational roller 3, along the rotational shaft, to the first digit rotational roller 2. During the operation of the digital perpetual calendar clock, the driving device 5 is driven by the signals to intermittently rotate a circular pin wheel 50 extending therefrom. Then, the circular pin wheel 50 can press against the slot-type wheel 34 on the outer side of the second digit rotational roller 3; in this way, the slot-type wheel 34 can drive the second digit rotational roller 3 to rotate counterclockwise toward the rotational shaft in stepping manner. During the process of the rotation, each page sheet 30 is turned down with the change of the angle, and the page sheet 30 turned down will connect to the next page sheet 30 blocked by the blocking element 6 in order to show a plane with digit.

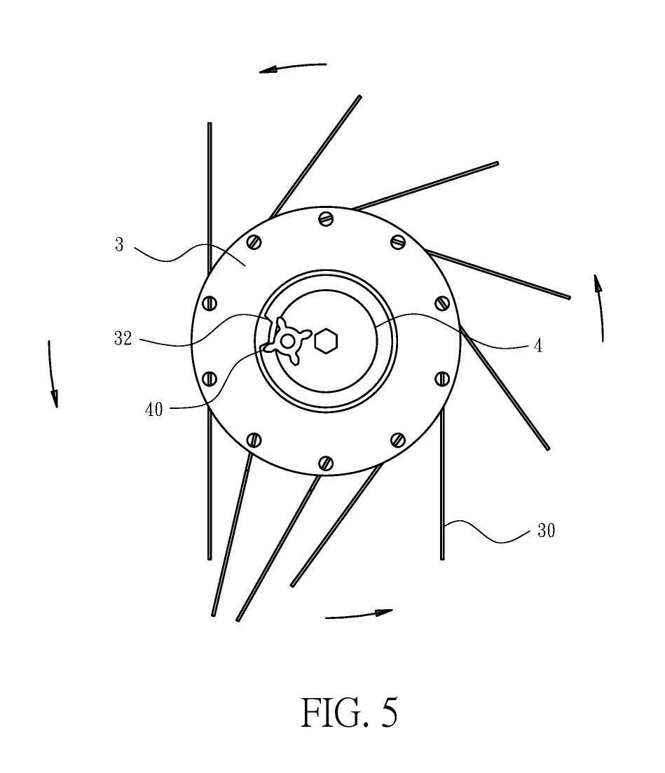

With reference to FIG. 5 for the second schematic view of the operation status of the structure improvement of the digital perpetual calendar clock in accordance with the present invention, FIG. 5 shows the view angle from the inner side of the second digit rotational roller 3, along the rotational shaft, to the first digit rotational roller 2. When the second digit rotational roller 3 rotates during the operation of the digital perpetual calendar clock, the protrusion block 32, disposed on the inner edge of the recess where the carrying shaft member 4 is embedded, simultaneously rotates. After rotating for a predetermined angle, the protrusion block 32 contacts the rotational teeth member 40 on the carrying shaft member 4, such that the rotation of the second digit rotational roller 3 can drive the rotational teeth member 40 on the carrying shaft member 4 to rotate along the shaft thereof.

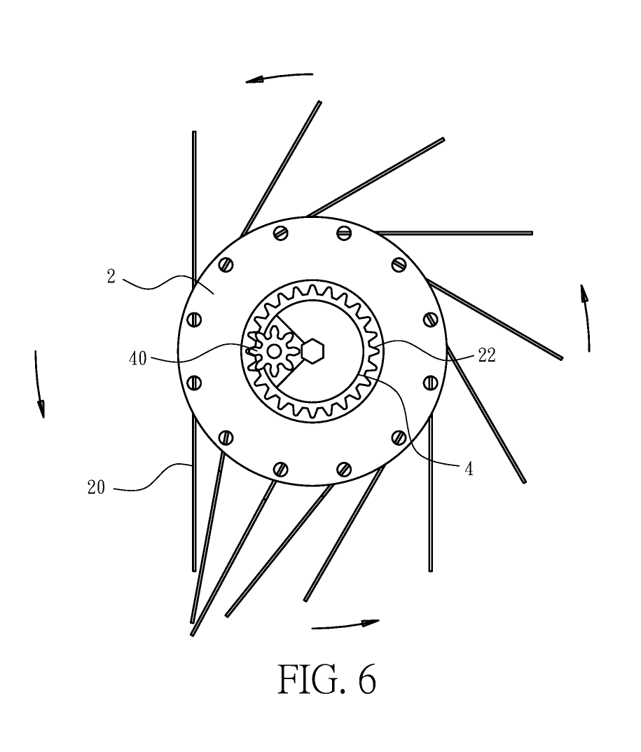

With reference to FIG. 6 for the third schematic view of the operation status of the structure improvement of the digital perpetual calendar clock in accordance with the present invention, FIG. 6 shows the view angle from the inner space of the carrying shaft member 4 to the first digit rotational roller 2. The 24 protrusion teeth 22, disposed on the inner edge of the recess where the carry shaft member 4 is embedded, is engaged with the rotational teeth member 40 at the inner side of the first digit rotational roller 2; thus, when the rotational teeth member 40 fixed on the carrying shaft member 4 rotates along the shaft thereof, the 24 protrusion teeth 22 can transmit power to drive the first digit rotational roller 2 to rotate. During the process of the rotation, each page sheet 20 is turned down with the change of the angle, and the page sheet 20 turned down will connect to the next page sheet 20 blocked by the blocking element 6 in order to show a plane with digit, such that the clock of the present invention can carry the ones place to the tens place.

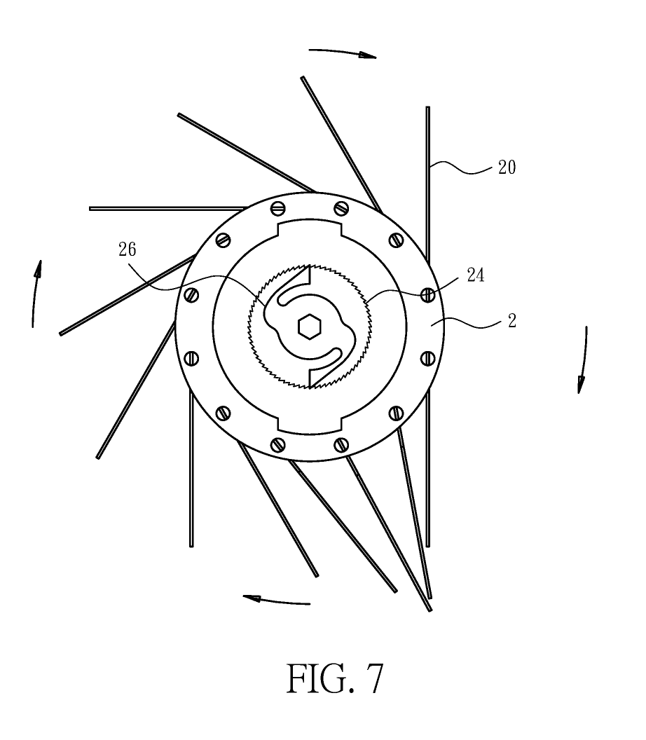

With reference to FIG. 7 for the fourth schematic view of the operation status of the structure improvement of the digital perpetual calendar clock in accordance with the present invention, FIG. 7 shows the view angle from the first digit rotational roller 2 to the second digit rotational roller 3; this view angle is contrary to the view angles of FIG. 4, FIG. 5 and FIG. 6; thus, FIG. 7 shows that the first digit rotational roller 2 rotates clockwise along the rotational shaft thereof. During the operation of the digital perpetual calendar clock, the limiting element 26, substantially being S-shaped, and the roller are disposed at the same shaft and fixed by the rotational shaft thereof. The limiting element 26 is embedded into the ring on one side of the first digit rotational roller 2 and the two ends, with horn shape, of the limiting element 26 are engaged with the converse teeth 24; the effect of the above structure is to limit the engaging angle between the converse teeth 24 and the limiting element 26 when the first digit rotational roller 2 rotates, such that the first digit rotational roller 2 will not rotate in the reverse direction.

According to the above embodiments, the structure improvement of the digital perpetual calendar clock in accordance with the present invention provides a flip clock with simple structure, which can reduce the cost incurred by the quantity of the page sheets. Further, with the core for clocking and the operation in stepping manner, the power consumption of the clock can be decreased, which can satisfy the requirement of long-term operation needed by perpetual calendar clock. Accordingly, the digital perpetual calendar clock provided by the present invention definitely has utility and novelty.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A structure improvement of a digital perpetual calendar clock, comprising:
an outer housing, comprising a clock window disposed on a surface of one side of the outer housing;
a first digit rotational roller, comprising a plurality of first page sheets disposed thereon at regular intervals and each of the first page sheets being provided with a part of one digit;
a second digit rotational roller, comprising a plurality of second page sheets disposed thereon at regular intervals and each of the second page sheets being provided with a part of one digit;
a carrying shaft member, one end of the carrying shaft member being embedded into the first digit rotational roller and the other end thereof being embedded into the second digit rotational roller, whereby the carrying shaft member being disposed between the first digit rotational roller and the second digit rotational roller at the same shaft;
a blocking element, disposed on a top of the clock window of the outer housing;
a driving device, adapted to drive the second digit rotational roller to rotate toward a bottom of the clock window of the outer housing;
wherein the first digit rotational roller and the second digit rotational roller are disposed in the outer housing, and positions of the first digit rotational roller and the second digit rotational roller are corresponding to the clock window of the outer housing;
wherein an inner edge, where the carrying shaft member are embedded, of the first digit rotational roller are provided with a plurality of first protrusion teeth, and an inner edge, where the carrying shaft member are embedded, of the second digit rotational roller are provided with a protrusion block;
wherein a rotational teeth member is disposed on the carrying shaft member and two sides of the rotational teeth member are provided with a plurality of second protrusion teeth, wherein each of the second protrusion teeth at one side of the rotational teeth member is disposed inside each of the first protrusion teeth of the first digit rotational roller, and each of the second protrusion teeth at the other side of the rotational teeth member is disposed toward the second digit rotational roller;
wherein a cushion for decreasing frictional force is disposed on and extends from an edge of the carrying shaft member and the cushion is provided with a hole penetrating through the cushion for containing the rotational teeth member;
wherein when the second digit rotational roller is driven to rotate, the protrusion block disposed in the inner edge of the second digit rotational roller presses against the second protrusion teeth disposed on one side of the rotational teeth member to make the rotational teeth member rotate and further drive the first digit rotational roller to rotate to carry via the second protrusion teeth disposed on the other side of the rotational teeth member engaged with the first protrusion teeth disposed on the inner edge of the first digit rotational roller;
wherein with an angle change of the first digit rotational roller and the second digit rotational roller rotating, each of the first page sheets and the second page sheets is able to be turned downward via the blocking member, whereby two of the first page sheets and two of the second page sheets are spread to show the digits thereon.

2. The structure improvement of the digital perpetual calendar clock of claim 1, wherein:
12 first page sheets are disposed on the first digit rotational roller at regular intervals;
23 first protrusion teeth are disposed on the inner edge, where the carrying shaft member are embedded, of the first digit rotational roller; and
10 second page sheets are disposed on the second digit rotational roller at regular intervals.

3. The structure improvement of the digital perpetual calendar clock of claim 1 or claim 2, wherein:
8 second protrusion teeth are disposed on one side of the carry teeth member and engaged with the 24 first protrusion teeth of the first digit rotational roller; 4 second protrusion teeth disposed on the other side of the carry teeth member are corresponding to and parallel to 8 second protrusion teeth, and disposed toward the second digit rotational roller; and
wherein when the second digit rotational roller are driven to rotate, the protrusion block disposed on the inner edge thereof presses against the 4 second protrusion teeth of the rotational teeth member to make the rotational teeth member to rotate; 8 second protrusion teeth, parallel to 4 second protrusion teeth, disposed on the other side of the rotational teeth member drive the first digit rotational roller.

4. The structure improvement of the digital perpetual calendar clock of claim 1 or claim 2, wherein:
a limiting element is disposed on the other side, where the carrying shaft member is embedded, of the first digit rotational roller for preventing the first digit rotational roller from rotating reversely.

5. The structure improvement of the digital perpetual calendar clock of claim 3, wherein:
a limiting element is disposed on the other side, where the carrying shaft member is embedded, of the first digit rotational roller for preventing the first digit rotational roller from rotating reversely.

6. The structure improvement of the digital perpetual calendar clock of claim 1 or claim 2, wherein:
a carrying element is disposed on the other side, where the carrying shaft member is embedded, of the first digit rotational roller, and the carrying element is used to transmit a carrying signal to an external device after a rotational angle of the first digit rotational roller is accumulated to a predetermined degree to contact the carrying element.

7. The structure improvement of the digital perpetual calendar clock of claim 1 or claim 2, wherein:
a slot-type wheel is disposed on the other side, where the carrying shaft member is embedded, of the second digit rotational roller, and the driving device drives the second digit rotational roller via a circular pin wheel pushing the slot-type wheel.

8. The structure improvement of the digital perpetual calendar clock of claim 3, wherein:

9. a slot-type wheel is disposed on the other side, where the carrying shaft member is embedded, of the second digit rotational roller, and the driving device drives the second digit rotational roller via a circular pin wheel pushing the slot-type wheel.

10. The structure improvement of the digital perpetual calendar clock of claim 1 or claim 2, wherein:
the driving device drives the second digit rotational roller to rotate by intermittent operation.

11. The structure improvement of the digital perpetual calendar clock of claim 3, wherein:
the driving device drives the second digit rotational roller to rotate by intermittent operation.
